(19) United States
(12) Patent Application Publication
(10) Pub. No.: US 2015/0033916 A1
(43) Pub. Date: Feb. 5, 2015

(54) Wide-Angled Wrench

(71) Applicants: Chung-Cheng Yang, Taichung City (TW); Hsin-Hung Yang, Taichung City (TW)

(72) Inventors: Chung-Cheng Yang, Taichung City (TW); Hsin-Hung Yang, Taichung City (TW)

(21) Appl. No.: 14/519,306

(22) Filed: Oct. 21, 2014

Related U.S. Application Data
(63) Continuation-in-part of application No. 13/310,842, filed on Dec. 5, 2011.

(51) Int. Cl. B25B 23/00

(52) U.S. Cl. CPC B25B 23/0028; B25B 23/0035
USPC 81/177.8

(57) ABSTRACT

A wide-angled wrench includes a handle, a connector, and a tool head. The connector is provided with two mounting channels each provided with a receiving recess. The handle has a first pivot portion provided with a plurality of first positioning grooves. The tool head has a second pivot portion provided with a plurality of second positioning grooves. The wide-angled wrench further comprises two elastic plates mounted in the receiving recess of each of the mounting channels. Each of the elastic plates is provided with a positioning projection. The positioning projection of a first one of the elastic plates is positioned in one of the first positioning grooves of the handle. The positioning projection of a second one of the elastic plates is positioned in one of the second positioning grooves of the tool head.

### CROSS-REFERENCES TO RELATED APPLICATIONS

The present invention is a continuation-in-part application of the co-pending U.S. Ser. No. 13/310,842.

### BACKGROUND OF THE INVENTION

1. Field of the Invention

The present invention relates to a hand tool and, more particularly, to a wide-angled wrench whose working angles can be adjusted.

2. Description of the Related Art

A conventional wrench comprises a handle and a tool head. Thus, the conventional wrench is used to drive and rotate a screw member, such as a screw, nut, bolt and the like. However, the conventional wrench has a fixed structure so that the working angles of the handle and the tool head cannot be adjusted freely, and the conventional wrench cannot be easily operated in a narrow working zone, such as an engine room and the like, thereby greatly causing inconvenience to the user when operating the conventional wrench in the narrow working zone.

### BRIEF SUMMARY OF THE INVENTION

In accordance with the present invention, there is provided a wide-angled wrench comprising a handle, a connector connected with the handle, and a tool head connected with the connector. The connector is provided with two mounting channels formed on two opposite ends thereof. Each of the mounting channels of the connector is provided with a through hole, a screw hole and a receiving recess. The handle has an end provided with a first pivot portion mounted in a first one of the mounting channels of the connector. The first pivot portion of the handle is provided with a first pivot hole. The first pivot portion of the handle has an arcuate face provided with a plurality of first positioning grooves. The tool head has an end provided with a second pivot portion mounted in a second one of the mounting channels of the connector. The second pivot portion of the tool head is provided with a second pivot hole. The second pivot portion of the tool head has an arcuate face provided with a plurality of second positioning grooves. The wide-angled wrench further comprises two screws mounted on the connector. A first one of the screws is extended through the through hole of the first one of the mounting channels of the connector and the first pivot hole of the first pivot portion of the handle, and is screwed into the screw hole of the first one of the mounting channels of the connector. A second one of the screws is extended through the through hole of the second one of the mounting channels of the connector and the second pivot hole of the second pivot portion of the tool head, and is screwed into the screw hole of the second one of the mounting channels of the connector. The wide-angled wrench further comprises two elastic plates mounted in the receiving recess of each of the mounting channels of the connector. Each of the elastic plates is provided with a positioning projection. The positioning projection of a first one of the elastic plates is positioned in one of the first positioning grooves of the first pivot portion of the handle. The positioning projection of a second one of the elastic plates is positioned in one of the second positioning grooves of the second pivot portion of the tool head.

According to the primary advantage of the present invention, the positioning projection of the first one of the elastic plates is selectively positioned in one of the first positioning grooves of the first pivot portion of the handle, and the positioning projection of the second one of the elastic plates is selectively positioned in one of the second positioning grooves of the second pivot portion of the tool head, so that the angles of the handle and the tool head relative to the connector can be changed to freely adjust the working angles of the wide-angled wrench, thereby facilitating the wide-angled wrench being operated in a narrower working zone.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a wide-angled wrench in accordance with the preferred embodiment of the present invention.

FIG. 2 is a top cross-sectional assembly view of the wide-angled wrench as shown in FIG. 1.

FIG. 3 is a cross-sectional view of the wide-angled wrench taken along line 3-3 as shown in FIG. 3.

FIG. 4 is a perspective assembly view of the wide-angled wrench as shown in FIG. 1.

FIG. 5 is a schematic operational view of the wide-angled wrench as shown in FIG. 4 in use.

FIG. 6 is a schematic operational view of the wide-angled wrench as shown in FIG. 2.

FIG. 7 is a schematic operational view of the wide-angled wrench as shown in FIG. 6.

FIG. 8 is an exploded perspective view of a wide-angled wrench in accordance with another preferred embodiment of the present invention.

FIG. 9 is a top cross-sectional assembly view of the wide-angled wrench as shown in FIG. 8.

FIG. 10 is a cross-sectional view of the wide-angled wrench taken along line 10-10 as shown in FIG. 9.

FIG. 11 is a schematic operational view of the wide-angled wrench as shown in FIG. 10.

FIG. 12 is a top cross-sectional assembly view of a wide-angled wrench in accordance with another preferred embodiment of the present invention.

### DETAILED DESCRIPTION OF THE INVENTION

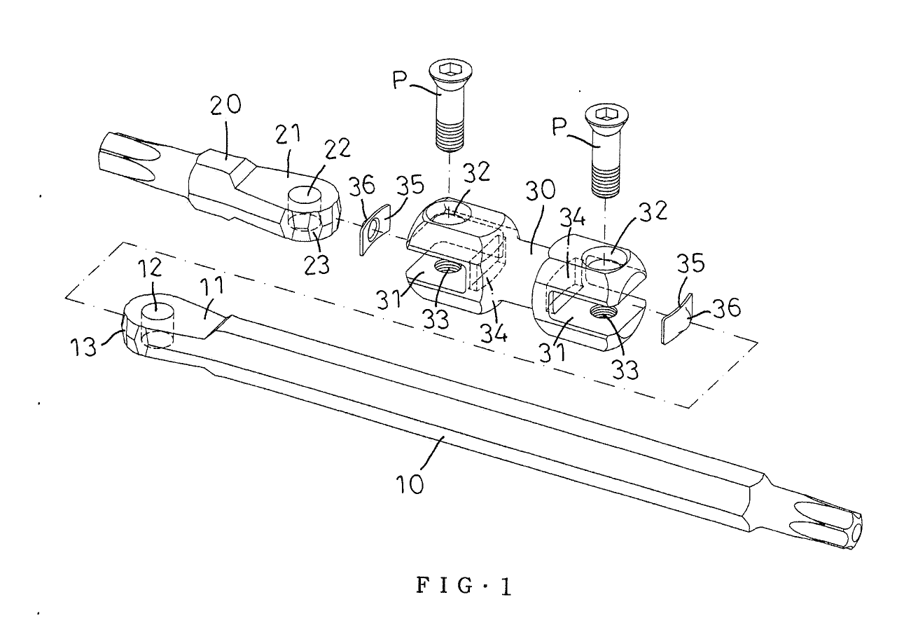

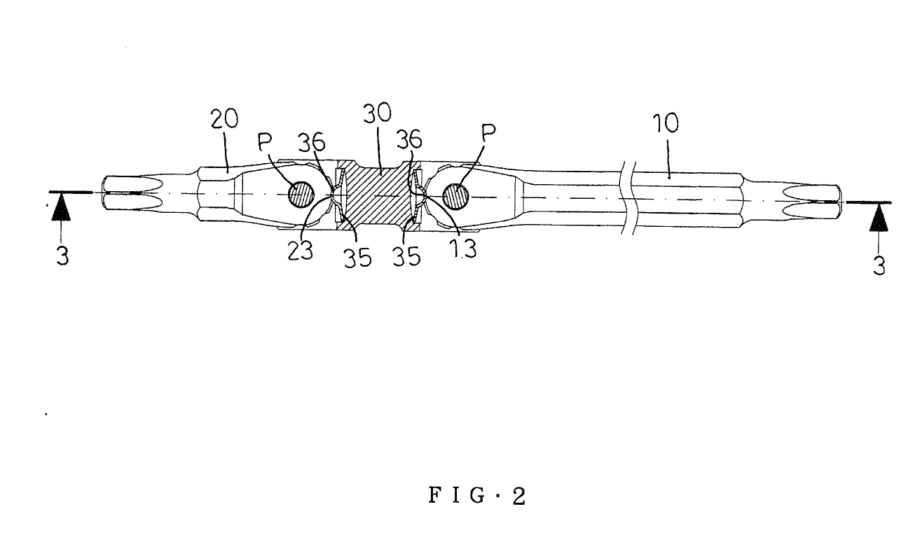

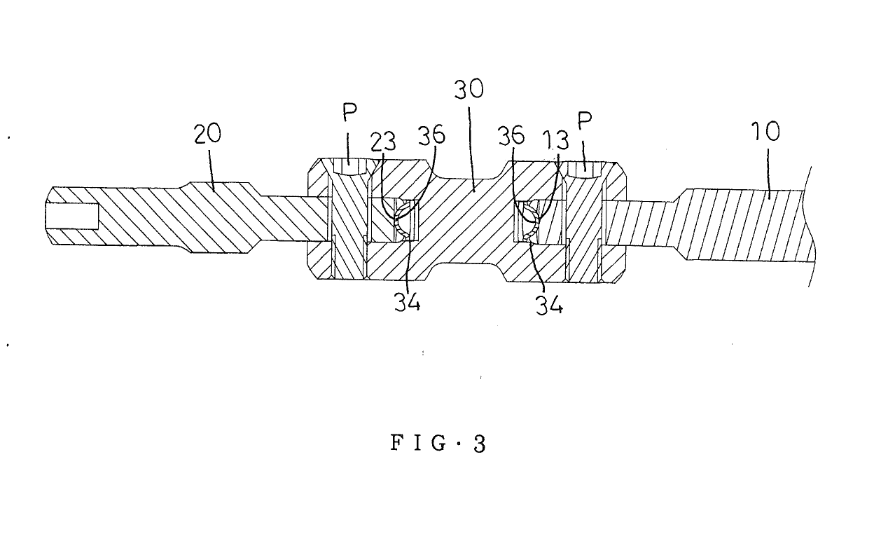

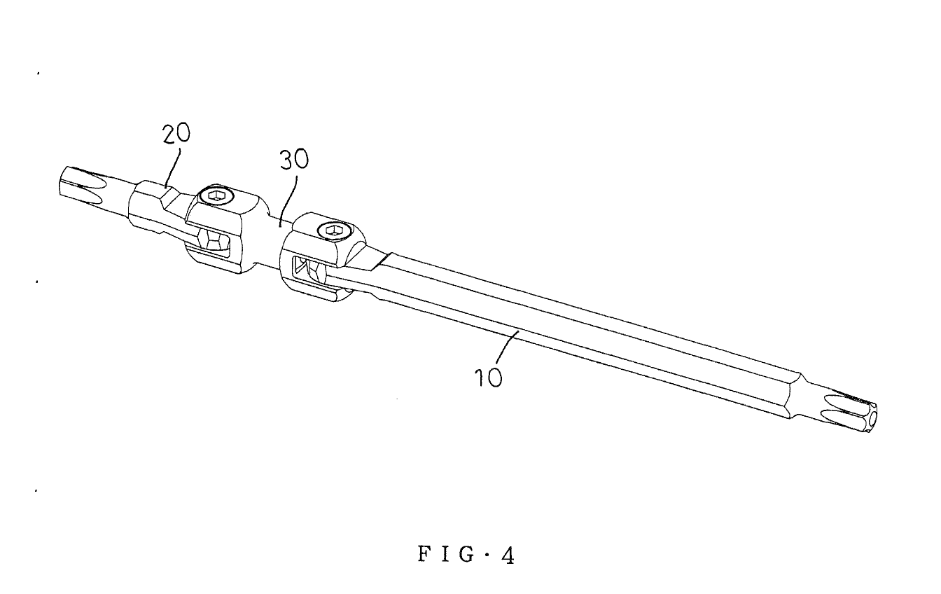

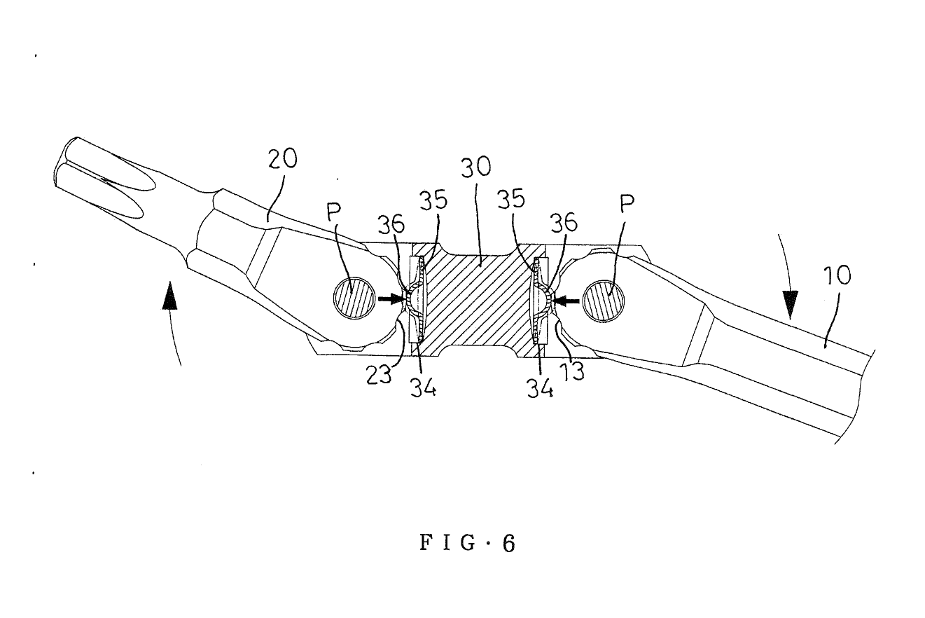

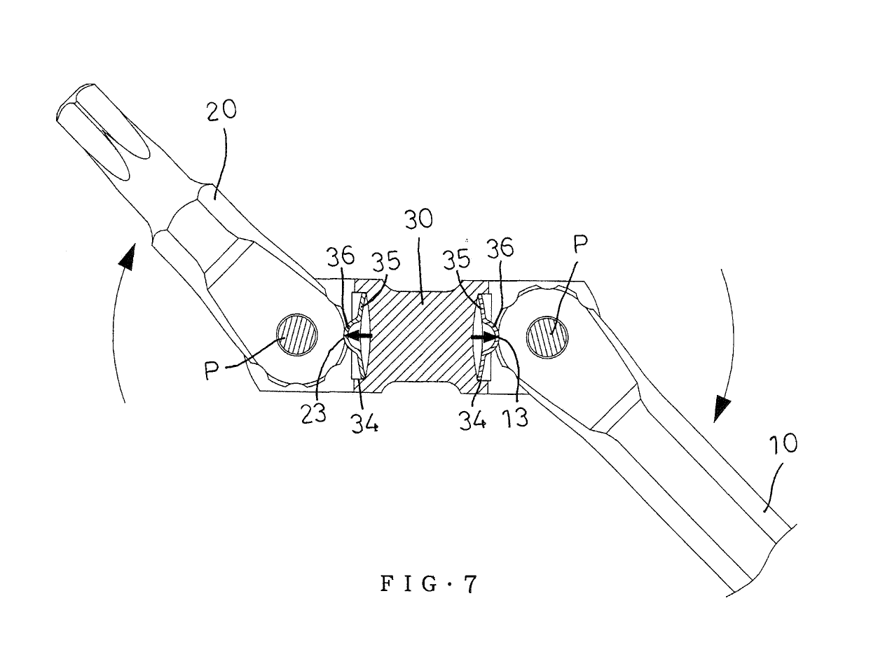

Referring to the drawings and initially to FIGS. 1-7, a wide-angled wrench in accordance with the preferred embodiment of the present invention comprises a handle 10, a connector 30 connected with the handle 10, and a tool head 20 connected with the connector 30.

The connector 30 is provided with two mounting channels 31 formed on two opposite ends thereof Each of the mounting channels 31 of the connector 30 has a substantially U-shaped profile and is provided with a through hole 32, a screw hole 33 and a receiving recess 34.

The handle 10 has an end provided with a substantially semi-circular first pivot portion 11 mounted in a first one of the mounting channels 31 of the connector 30. The first pivot portion 11 of the handle 10 is provided with a first pivot hole 12. The first pivot portion 11 of the handle 10 has an arcuate face provided with a plurality of first positioning grooves 13.

The tool head 20 has an end provided with a substantially semi-circular second pivot portion 21 mounted in a second one of the mounting channels 31 of the connector 30. The second pivot portion 21 of the tool head 20 is provided with a second pivot hole 22. The second pivot portion 21 of the tool head 20 has an arcuate face provided with a plurality of second positioning grooves 23.

The wide-angled wrench further comprises two screws “P” mounted on the connector 30. A first one of the screws “P” is extended through the through hole 32 of the first one of the mounting channels 31 of the connector 30 and the first pivot hole 12 of the first pivot portion 11 of the handle 10, and is screwed into the screw hole 33 of the first one of the mounting channels 31 of the connector 30, so that the handle 10 is connected with the connector 30. A second one of the screws “P” is extended through the through hole 32 of the second one of the mounting channels 31 of the connector 30 and the second pivot hole 22 of the second pivot portion 21 of the tool head 20, and is screwed into the screw hole 33 of the second one of the mounting channels 31 of the connector 30, so that the tool head 20 is connected with the connector 30.

The wide-angled wrench further comprises two elastic plates 35 mounted in the receiving recess 34 of each of the mounting channels 31 of the connector 30. Each of the elastic plates 35 has an arcuate shape and is provided with a positioning projection 36. The positioning projection 36 of a first one of the elastic plates 35 is positioned in one of the first positioning grooves 13 of the first pivot portion 11 of the handle 10. The positioning projection 36 of a second one of the elastic plates 35 is positioned in one of the second positioning grooves 23 of the second pivot portion 21 of the tool head 20.

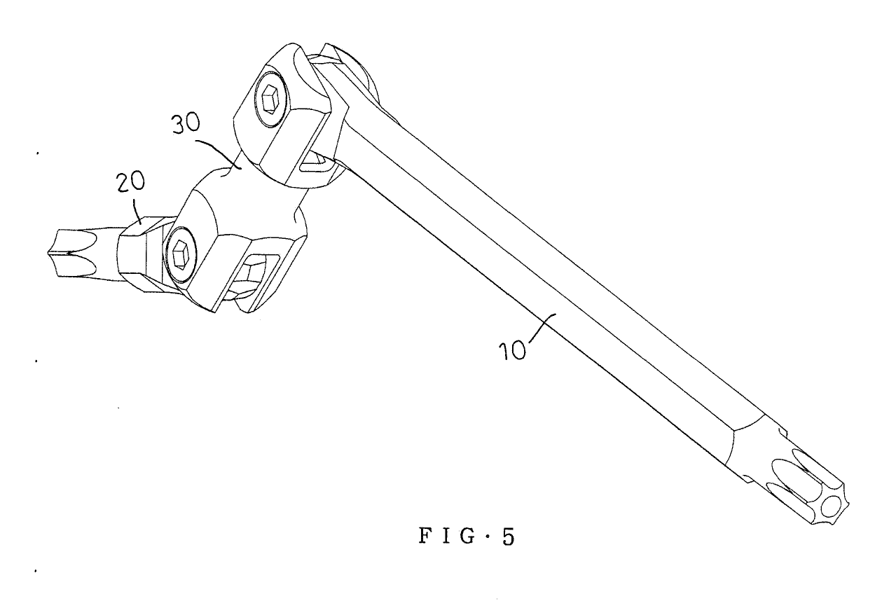

In operation, referring to FIGS. 5-7 with reference to FIGS. 1-4, the handle 10 and the tool head 20 are pivoted relative to the connector 30 to adjust the angles of the handle 10 and the tool head 20 relative to the connector 30 so that the working angles of the wide-angled wrench can be adjusted freely, and the wide-angled wrench is available for operation in a limited working environment, such as an engine room. At this time, the positioning projection 36 of the first one of the elastic plates 35 is positioned in one of the first positioning grooves 13 of the first pivot portion 11 of the handle 10 to position the handle 10 temporarily, and the positioning projection 36 of the second one of the elastic plates 35 is positioned in one of the second positioning grooves 23 of the second pivot portion 21 of the tool head 20 to position the tool head 20 temporarily.

Accordingly, the positioning projection 36 of the first one of the elastic plates 35 is selectively positioned in one of the first positioning grooves 13 of the first pivot portion 11 of the handle 10, and the positioning projection 36 of the second one of the elastic plates 35 is selectively positioned in one of the second positioning grooves 23 of the second pivot portion 21 of the tool head 20, so that the angles of the handle 10 and the tool head 20 relative to the connector 30 can be changed to freely adjust the working angles of the wide-angled wrench, thereby facilitating the wide-angled wrench being operated in a narrower working zone.

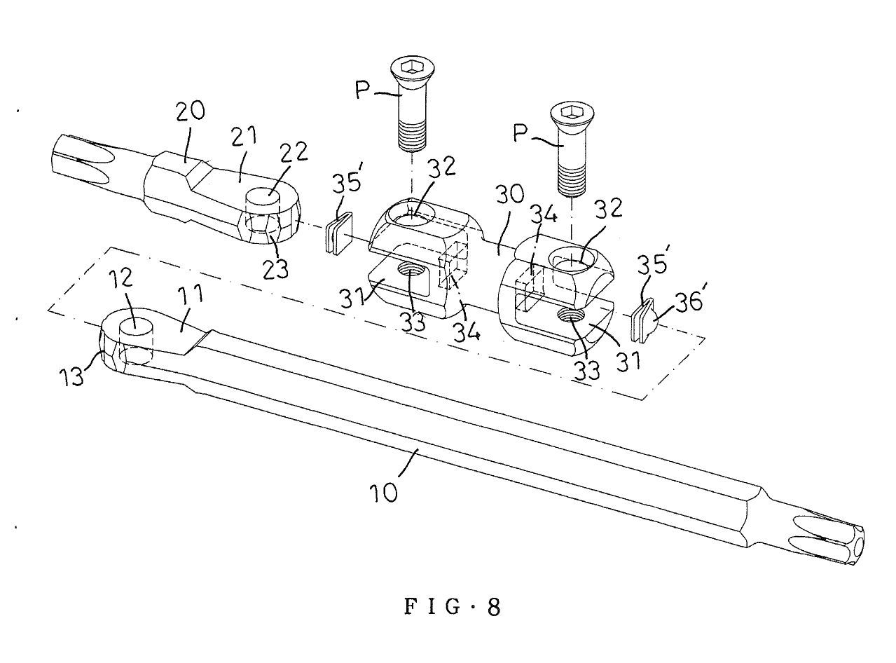

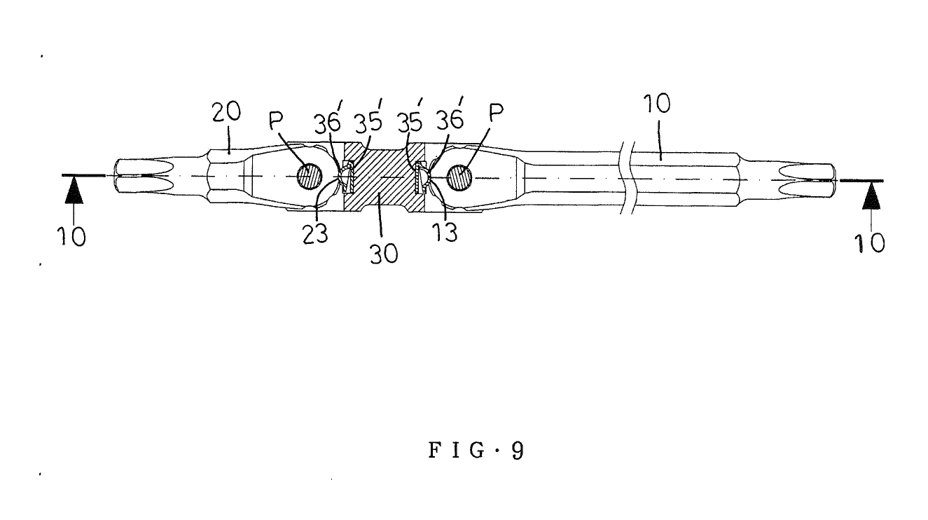

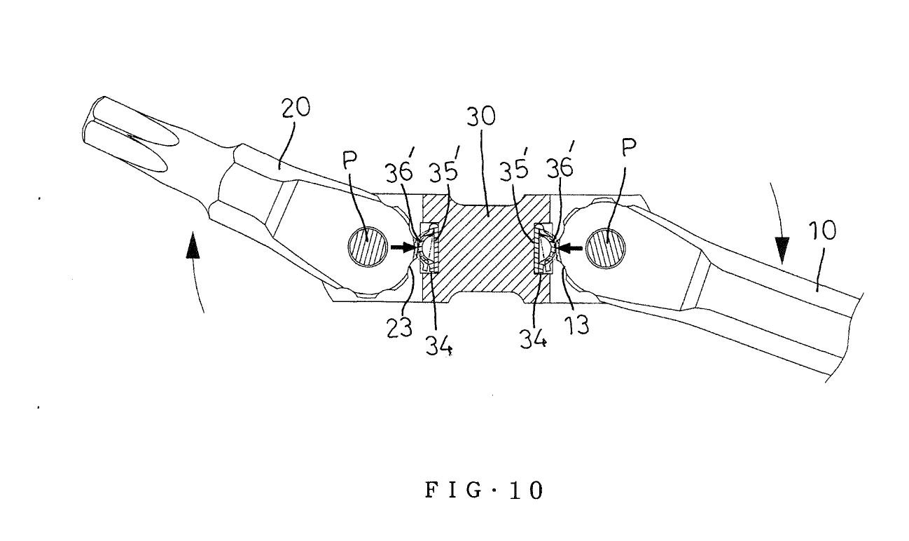

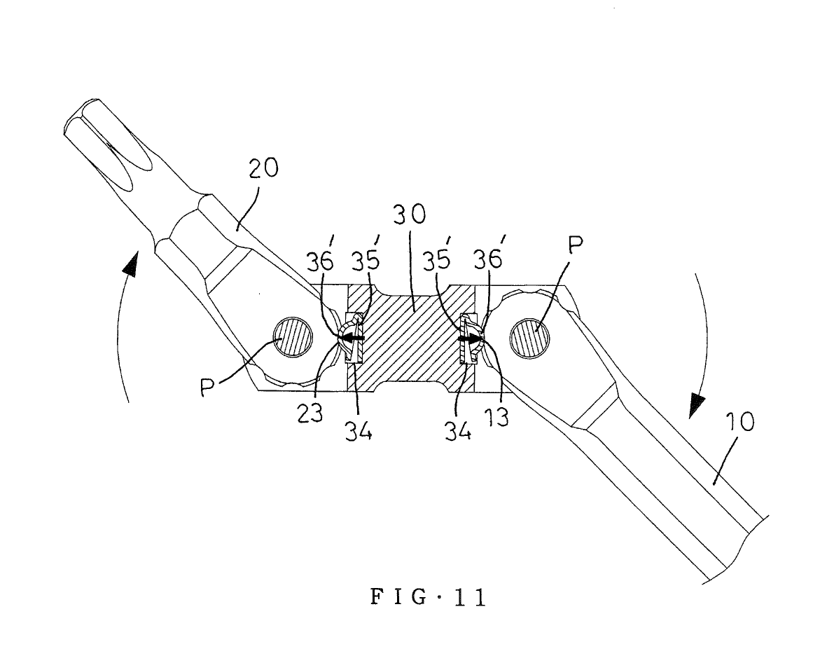

Referring to FIGS. 8-11, each of the elastic plates 35′ has a V-shaped profile and has an inner face received in the receiving recess 34 of each of the mounting channels 31 of the connector 30 and an outer face provided with the positioning projection 36′.

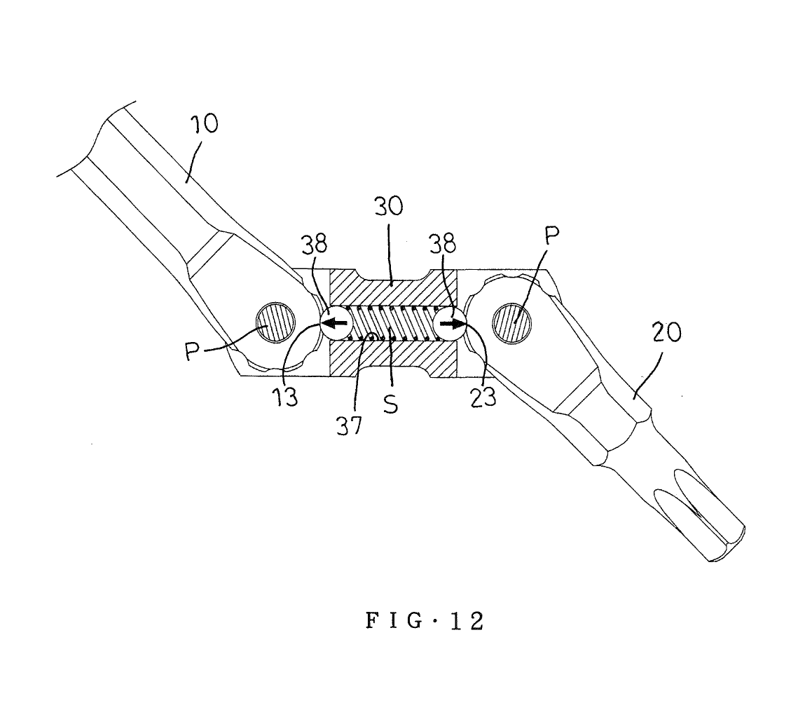

Referring to FIG. 12, the connector 30 is provided with a radial hole 37 disposed between the mounting channels 31 of the connector 30. The wide-angled wrench further comprises two positioning members 38 mounted in the radial hole 37 of the connector 30, and an elastic member “S” mounted in the radial hole 37 of the connector 30 and biased between the positioning members 38. Each of the positioning members 38 is preferably a steel ball. A first one of the positioning members 38 is positioned in one of the first positioning grooves 13 of the first pivot portion 11 of the handle 10, and a second one of the positioning members 38 is positioned in one of the second positioning grooves 23 of the second pivot portion 21 of the tool head 20.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A wide-angled wrench comprising:
a handle;
a connector connected with the handle; and
a tool head connected with the connector;
wherein:
the connector is provided with two mounting channels formed on two opposite ends thereof;
each of the mounting channels of the connector is provided with a through hole, a screw hole and a receiving recess;
the handle has an end provided with a first pivot portion mounted in a first one of the mounting channels of the connector;
the first pivot portion of the handle is provided with a first pivot hole;
the first pivot portion of the handle has an arcuate face provided with a plurality of first positioning grooves;
the tool head has an end provided with a second pivot portion mounted in a second one of the mounting channels of the connector;
the second pivot portion of the tool head is provided with a second pivot hole;
the second pivot portion of the tool head has an arcuate face provided with a plurality of second positioning grooves;
the wide-angled wrench further comprises two screws mounted on the connector;
a first one of the screws is extended through the through hole of the first one of the mounting channels of the connector and the first pivot hole of the first pivot portion of the handle, and is screwed into the screw hole of the first one of the mounting channels of the connector;
a second one of the screws is extended through the through hole of the second one of the mounting channels of the connector and the second pivot hole of the second pivot portion of the tool head, and is screwed into the screw hole of the second one of the mounting channels of the connector;
the wide-angled wrench further comprises two elastic plates mounted in the receiving recess of each of the mounting channels of the connector;
each of the elastic plates is provided with a positioning projection;
the positioning projection of a first one of the elastic plates is positioned in one of the first positioning grooves of the first pivot portion of the handle; and
the positioning projection of a second one of the elastic plates is positioned in one of the second positioning grooves of the second pivot portion of the tool head.

2. The wide-angled wrench of claim 1, wherein each of the elastic plates has an arcuate shape.

3. The wide-angled wrench of claim 1, wherein each of the elastic plates has a V-shaped profile.
